(19) United States
(12) Patent Application Publication
(10) Pub. No.: US 2026/0170357 A1
(43) Pub. Date: Jun. 18, 2026

(54) SYSTEM AND METHOD FOR GROUNDING LARGE LANGUAGE MODEL REASONS WITH KNOWLEDGE GRAPHS

(71) Applicant: JPMorgan Chase Bank, N.A., New York, NY (US)

(72) Inventors: Alfonso AMAYUELAS FERNANDEZ, Goleta, CA (US); Simerjot KAUR, Jersey City, NJ (US); Joy SAIN, Jamaica, NY (US); Charese SMILEY, Bristol, WI (US); Xiaomo LIU, Manhasset, NY (US)

(73) Assignee: JPMorgan Chase Bank, N.A., New York, NY (US)

(21) Appl. No.: 18/984,325

(22) Filed: Dec. 17, 2024

(51) Int. Cl. G06N 5/02

(52) U.S. Cl. CPC G06N 5/02

(57) ABSTRACT

Various methods and processes, apparatuses or systems, and media for performing a plurality of communications with a knowledge graph by a knowledge graph configured large language model (KGLLM) for answering a question are disclosed. The present disclosure provides receiving, at the KGLLM, the question; generating, by the KGLLM, a plurality of logical reasoning steps based on the received question; identifying and inputting, to the KGLLM, the knowledge graph based on the received question; for each of the plurality of logical reasoning steps: generating a prompt for a logical reasoning step, connecting to the knowledge graph, and retrieving corresponding pieces of information from the knowledge graph based on the generated prompt; and combining the pieces of information retrieved for deriving an answer to the question.

### TECHNICAL FIELD

This disclosure generally relates to grounding large language model reasons with knowledge graphs. More specifically, the present disclosure relates to integrating a knowledge graph with large language models to enable to answer natural language queries utilizing data embedded in the knowledge graph.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Large language models (LLMs) have shown remarkable versatility when answering questions in natural language, partly due to their generative capabilities, their extensive internal general knowledge and their external information. However, LLMs have a noticeable flaw that makes them generate plausible but ungrounded knowledge, known as hallucinations. Also, LLMs may generate content relying on their internal weights, which makes it difficult to connect with external sources. Such flaws have limited their use for industrial applications.

Moreover, these flaws have become more relevant in applied settings. Conventional LLMs are usually trained on general data. Accordingly, their knowledge and reasoning capabilities are fixed at the time of training. As a result, LLMs must be additionally trained or fined tuned for its application for providing grounded analysis and results. However, it is tedious process to fine-tune the LLMS for every use case for providing grounded knowledge. This difficulty becomes more relevant in organizations with internal proprietary data that the organization may not be willing or allowed to be trained on.

Moreover, when connecting LLMs are connected with external knowledge, conventional methodology assumes that the external knowledge is well represented in individual units, a document or table. However, external knowledge fails to capture relationships between concepts that may go beyond the individual document, leading to inaccurate results or analysis.

Accordingly, conventional LLM applications have been limited in applicability, and may require substantial preparatory work before the respective LLM may be directed to a particular use.

### SUMMARY

The present disclosure, through one or more of its various aspects, embodiments, and/or specific features or sub-components, provides, among other features, method for performing a plurality of communications with a knowledge graph by a knowledge graph configured large language model (KGLLM) for answering a question is provided. The method includes receiving, at the KGLLM executed by a processor, the question; generating, by the KGLLM, a plurality of logical reasoning steps based on the received question; identifying and inputting, to the KGLLM, the knowledge graph based on the received question; for each of the plurality of logical reasoning steps: generating a prompt for a logical reasoning step, connecting to the knowledge graph based on the generated prompt, and retrieving corresponding pieces of information from the knowledge graph based on the generated prompt; and combining the pieces of information retrieved in each of the plurality of logical reasoning steps for deriving an answer to the question.

In some embodiments, the question received is provided in natural language text.

In some embodiments, the knowledge graph includes a plurality of triples, in which each of the triples includes a pair of nodes connected by an edge, in which a node corresponds to a data entity and the edge indicates a relationship between the nodes, and in which the edge indicates a directionality of the relationship.

In some embodiments, the method may further include determining, by the KGLLM, a reasoning framework to apply to the question received among a plurality of reasoning frameworks.

In some embodiments, the reasoning framework is a chain-of-thought (CoT) framework.

In some embodiments, the reasoning framework is a tree-of-thought (ToT) framework.

In some embodiments, the reasoning framework is a graph-of-thought (GoT) framework.

In some embodiments, the plurality of reasoning steps is sequentially arranged.

In some embodiments, the plurality of reasoning steps is arranged across a plurality of levels.

In some embodiments, each of the plurality of levels includes a single logical reasoning step.

In some embodiments, at least one of the plurality of levels includes more than one logical reasoning step.

In some embodiments, at least two logical reasoning steps in a first level of the plurality of levels merges to a single logical reasoning step in a second level of the plurality of levels.

In some embodiments, the retrieved pieces of information include a triple from the knowledge graph, the triple including a pair of nodes connected with an edge.

In some embodiments, the retrieved pieces of information include a knowledge graph path from one node to another node.

In some embodiments, the KGLLM is configured to select a predefined action to perform, among a plurality of predefined actions, to connect with the knowledge graph.

In some embodiments, the predefined action is selected based on the logical reasoning step,

In some embodiments, the plurality of predefined actions includes identifying one or more related nodes in the knowledge graph with a semantic search, retrieving textual information for a specific node from the knowledge graph, retrieving neighbor information for the specific node, and providing a number of neighbors for a given node and edge type.

In some embodiments, the KGLLM is configured to automatically search the knowledge graph based on generated prompt for the logical reasoning step.

In some embodiments, a system for performing a plurality of communications with a knowledge graph by a KGLLM for answering a question is disclosed. The system may include: a processor; and a memory operatively connected to the processor via a communication interface, the memory storing computer readable instructions, when executed, causes the processor to: receiving, at the KGLLM, the question; generating, by the KGLLM, a plurality of logical reasoning steps based on the received question; identifying and inputting, to the KGLLM, the knowledge graph based on the received question; for each of the plurality of logical reasoning steps: generating a prompt for a logical reasoning step, connecting to the knowledge graph based on the generated prompt, and retrieving corresponding pieces of information from the knowledge graph based on the generated prompt; and combining the pieces of information retrieved in each of the plurality of logical reasoning steps for deriving an answer to the question.

In some embodiments, a non-transitory computer readable medium configured to store instructions for performing a plurality of communications with a knowledge graph by a KGLLM for answering a question is disclosed. The instructions, when executed, may cause a processor to perform the following: receiving, at the KGLLM, the question; generating, by the KGLLM, a plurality of logical reasoning steps based on the received question; identifying and inputting, to the KGLLM, the knowledge graph based on the received question; for each of the plurality of logical reasoning steps: generating a prompt for a logical reasoning step, connecting to the knowledge graph based on the generated prompt, and retrieving corresponding pieces of information from the knowledge graph based on the generated prompt; and combining the pieces of information retrieved in each of the plurality of logical reasoning steps for deriving an answer to the question.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a knowledge graph configured large language model (KGLLM) in accordance with an embodiment.

FIG. 2 illustrates a diagram of a network environment for implementing a KGLLM system in accordance with an embodiment.

FIG. 3 illustrates a system configuration diagram for implementing a KGLLM system in accordance with an embodiment.

FIG. 4 illustrates a method for providing an answer via a KGLLM system by leveraging a knowledge graph in accordance with an embodiment.

FIG. 5 illustrates a knowledge graph in accordance with an embodiment.

FIG. 6 illustrates a knowledge graph generated from textual information in accordance with an embodiment.

FIG. 7 illustrates a system flow of a KGLLM system in accordance with an embodiment.

FIG. 8 illustrates exemplary reasoning frameworks applied to a KGLLM system in accordance with an embodiment.

FIGS. 9A-9B illustrate exemplary process flows using a tree of thought reasoning framework in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

According to exemplary aspects, present disclosure allows large language models (LLMs) to be leveraged to knowledge graphs for providing an answer to a domain specific complex question requiring multiple levels of reasoning steps or analysis without performing prerequisite training for the respective domain. More specifically, the inputted question may be broken into sequential or chained multiple logical reasoning steps, and each of the multiple logical reasoning steps may be configured to interact with the knowledge graph for providing of an intermediate response, which may be chained together to provide an answer to the inputted question. By leveraging existing knowledge graphs and/or other topological information as inputs for each of the logical reasoning steps, LLMs may be configured to generate intermediate prompts for obtaining new grounded information without initially requiring training of LLMs for such prompting. Accordingly, LLMs may be leveraged for new set of information that the LLMs have not encountered without prior training, which allows for dynamic or impromptu configuration of LLMs for providing grounded information that were conventionally unavailable. Such dynamic or impromptu configuration of LLMs may lead to savings in computational resources that were conventionally expanded for training of LLMs. Further, based on the prompting of the dynamically configured LLMs, insights into the LLM's decision making process for performing a prediction may also be provided. Moreover, usage of knowledge graphs enhances traceability and transparency of the operations performed by the KGLLM.

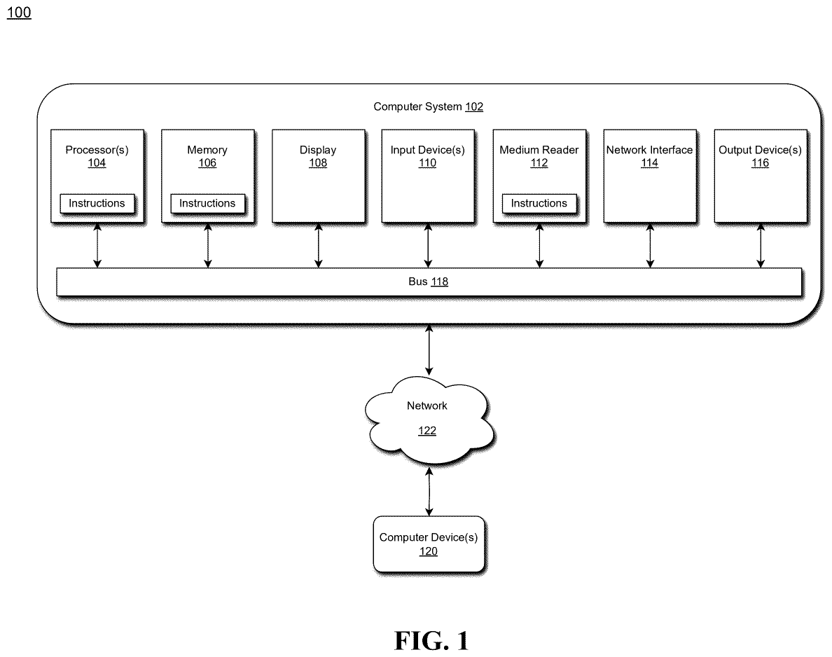

FIG. 1 is a system 100 for use in implementing a knowledge graph configured large language model (KGLLM) system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the KGLLM module implemented by the system 100 may allow for a KGLLM module to perform a multi-step reasoning analysis in a domain, in which KGLLM has not been previously trained, by leveraging a knowledge graph at each step of the multi-step reasoning analysis for providing a response.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

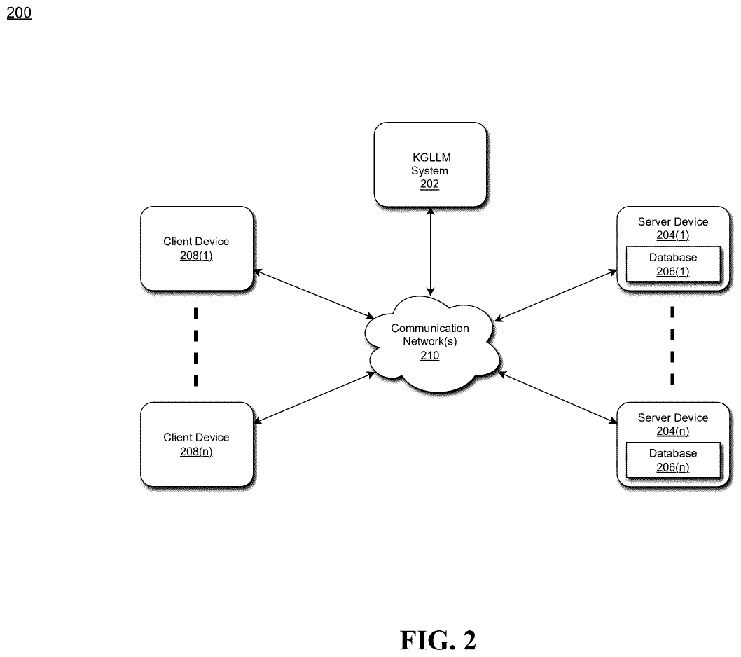

Referring to FIG. 2, a schematic of a network environment 200 for implementing a KGLLM is illustrated.

In some embodiments, the above-described problems associated with conventional knowledge graph completion tools may be overcome by implementing a KGLLM system 202 as illustrated in FIG. 2 that may be configured for implementing a KGLLM module configured for breaking down a question inputted to the KGLLM into chained multiple logical reasoning steps, applying the knowledge graph to each one of the chained multiple logical reasoning steps for retrieving pieces of information from the knowledge graph, and deriving an answer to the inputted question based on the pieces of information retrieved from the knowledge graph for each of the chained multiple logical reasoning steps.

The KGLLM system 202 may include one or more computer system 102s, as described with respect to FIG. 1, which in aggregate provides the necessary functions.

The KGLLM system 202 may store one or more applications that can include executable instructions that, when executed by the KGLLM system 202, cause the KGLLM system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the KGLLM system 202 itself, may be located in virtual server(s) running in a cloud-based computing environment rather than being tied to one or more specific physical network computing devices. Also, the application(s) may be running in one or more virtual machines (VMs) executing on the KGLLM system 202. Additionally, in one or more embodiments of this technology, virtual machine(s) running on the KGLLM system 202 may be managed or supervised by a hypervisor.

In the network environment 200 of FIG. 2, the KGLLM system 202 may be coupled to a plurality of server devices 204(1)-204(n) that hosts a plurality of databases 206(1)-206(n), and also to a plurality of client devices 208(1)-208(n) via communication network(s) 210. A communication interface of the KGLLM system 202, such as the network interface 114 of the computer system 102 of FIG. 1, operatively couples and communicates between the KGLLM system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the KGLLM system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The KGLLM system 202 may be a standalone device or integrated with one or more other devices or apparatuses, such as one or more of the server devices 204(1)-204(n), for example. In one particular example, the KGLLM system 202 may be hosted by one of the server devices 204(1)-204(n), and other arrangements are also possible. Moreover, one or more of the devices of the KGLLM system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the KGLLM system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the KGLLM system 202 that may efficiently provide a KGLLM module configured for breaking down a question inputted to the KGLLM into multiple logical reasoning steps, applying the knowledge graph to each one of the multiple logical reasoning steps for retrieving pieces of information from the knowledge graph, and deriving an answer to the inputted question based on the pieces of information retrieved from the knowledge graph for each of the multiple logical reasoning steps.

The client devices 208(1)-208(n) may run interface applications, such as standard web browsers or standalone client applications, which may provide an interface to communicate with the KGLLM system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the KGLLM system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the KGLLM system 202, the server devices 204(1)-204(n), or the client devices 208(1)-208(n), for example, may be configured to operate as virtual instances on the same physical machine. For example, one or more of the KGLLM system 202, the server devices 204(1)-204(n), or the client devices 208(1)-208(n) may operate on the same physical device rather than as separate devices communicating through communication network(s) 210. Additionally, there may be more or fewer KGLLM system s 202, server devices 204(1)-204(n), or client devices 208(1)-208(n) than illustrated in FIG. 2. In some embodiments, the KGLLM system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

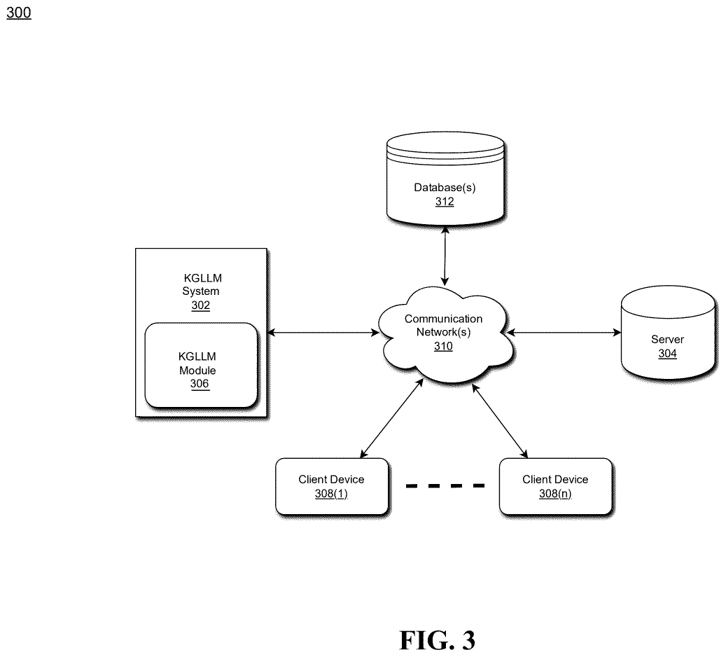

FIG. 3 illustrates a system diagram for implementing a KGLLM system in accordance with an embodiment.

As illustrated in FIG. 3, the system 300 may include a KGLLM system 302 within which a KGLLM module 306 is embedded, a server 304, a database(s) 312, a plurality of client devices 308(1) . . . 308(n), and a communication network 310.

In some embodiments, the KGLLM system 302 including the KGLLM module 306 may be connected to the server 304, and the database(s) 312 via the communication network 310. The KGLLM system 302 may also be connected to the plurality of client devices 308(1) . . . 308(n) via the communication network 310, but the disclosure is not limited thereto. The database(s) 312 may include one or more rule databases.

In an embodiment, the KGLLM system 302 is described and shown in FIG. 3 as including the KGLLM module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the KGLLM module 306 may be configured to receive real-time feed of data from the plurality of client devices 308(1) . . . 308(n) and secondary sources via the communication network 310.

The KPLLM module 306 may be configured to: receive the question provided in natural language; generate a plurality of reasoning steps based on the received question; identify and input a knowledge graph based on the received question; for each of the plurality of logical reasoning steps: generate a prompt for a logical reasoning step, connect to the knowledge graph, and retrieve corresponding pieces of information based on the generated prompt; and combine the pieces of information retrieved for deriving an answer to the question, but the disclosure is not limited thereto.

The plurality of client devices 308(1) . . . 308(n) are illustrated as being in communication with the KGLLM system 302. In this regard, the plurality of client devices 308(1) . . . 308(n) may be “clients” (e.g., customers) of the KGLLM system 302 and are described herein as such. Nevertheless, it is to be known and understood that the plurality of client devices 308(1) . . . 308(n) need not necessarily be “clients” of the KGLLM system 302, or any entity described in association therewith herein. Any additional or alternative relationship may exist between either or both of the plurality of client devices 308(1) . . . 308(n) and the KGLLM system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the KGLLM system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The KGLLM system 302 may be the same or similar to the KGLLM system 202 as described with respect to FIG. 2, including any features or combination of features described with respect thereto.

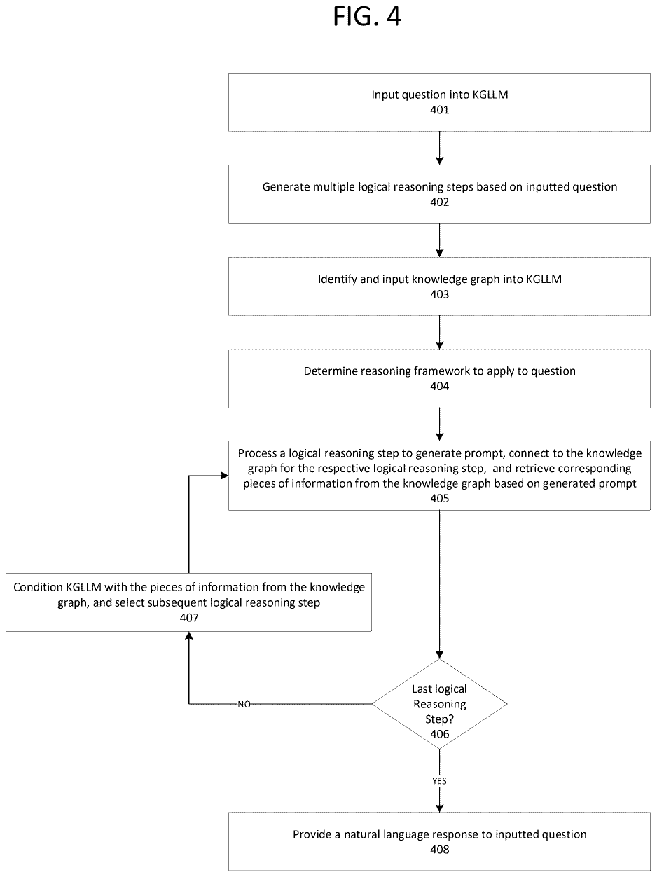

FIG. 4 illustrates a method for providing an answer via a KGLLM system by leveraging a knowledge graph in accordance with an embodiment.

According to exemplary aspects, when a KGLLM is provided with a knowledge graph, the KGLLM may be able to generate an accurate and grounded output without prior training. The knowledge graphs may be domain specific knowledge graphs, such as academic, e-commerce, healthcare and the like. Conventionally, an LLM may require training in domain specific information before it can effectively be utilized for providing a grounded output that is supported by evidence. However, LLMs cannot realistically constantly be trained on specific domains or internal data to effectively keep the LLMs up to date for effective usage. Accordingly, by utilizing the underlying data that are constantly updated, such as knowledge graphs, LLMs may be updated dynamically without necessitating constat training for providing a dynamically updated LLM.

In addition to the above, for more complex questions, a knowledge graph may not be effectively leveraged on the LLMs due to the large number of variables and relationships, and may result in inaccurate output without providing sufficient data for troubleshooting.

According to exemplary aspects, an underlying LLM of a KGLLM may refer to a type of artificial intelligence model or system that may generate natural language based on a large amounts of training data. According to exemplary aspects, the underlying LLM of the KGLLM may be built on neural networks utilizing one or more transformers to process and produce language. The underlying LLM may be configured to generate natural language text and may include generative AI abilities, and may be capable of processing more complex questions, including a question requiring multiple levels of logical operations and analysis. One of the limitations of a conventional LLM includes the need for additional training before the respective LLM is capable of competently handling a question in a domain that the respective LLM is unfamiliar with. However, the KGLLM may be capable of processing questions in a new domain by dynamically incorporating one or more knowledge graphs without requiring training beforehand. As a result, the KGLLM may be deployed immediately and dynamically to new domains without performing training in such domains beforehand as conventionally required.

In operation 401, a question may be inputted to a KGLLM. In an example, the question may be inputted as natural language text. According to exemplary aspects, the natural language question may include multiple pieces of information indicating a premise (or information held to be true or known by a user), a domain, a question being asked and/or the like. However, aspects of the present disclosure are not limited thereto, such that the question may be provided in a differing format and may include different set of information.

In operation 402, multiple logical reasoning steps may be generated based on the inputted question. According to exemplary aspects, the question inputted may be a more complex question, requiring multiple logical reasoning steps. Moreover, the natural language question may include multiple pieces of information or require multiple pieces of information to be obtained for answering the question.

According to exemplary aspects, generating of multiple logical reasoning steps from a question may include (i) decomposing the inputted question into multiple logical reasoning steps that may be evaluated individually, and (ii) after the decomposing, the broken down logical reasoning steps are generated as intermediate inquiries or operations to be processed by the KGLLM.

As a simple example, a question may specify the following: “Tim has nine golf balls, and buys three sleeves of golf balls. How many golf balls does Tim has now?” Here, the end question may inquire how many golf balls Tim has. However, in order to answer the question being asked, intermediate questions or logical reasoning steps may be generated, which may provide one or more intermediate responses. Further, if an intermediate question or logical reasoning step has multiple possibilities, the intermediate question or logical step may lead to a level of sub-intermediate questions or sub-logical reasoning steps based on an answer by a preceding intermediate question or intermediate logical reasoning step.

In the above noted example, an intermediate question may include a question for determining how many golf balls are included in a sleeve of golf balls. In this aspect, it may be determined that three golf balls are typically included in a single sleeve of golf balls. Then the next intermediate question or logical step may require how many balls are bought by Tim, which will result in an answer of nine. Based on this response, the logical step or intermediate question may ask the number of balls calculated to be added to the number of balls already in possession by Tim to provide a total number of golf balls of eighteen.

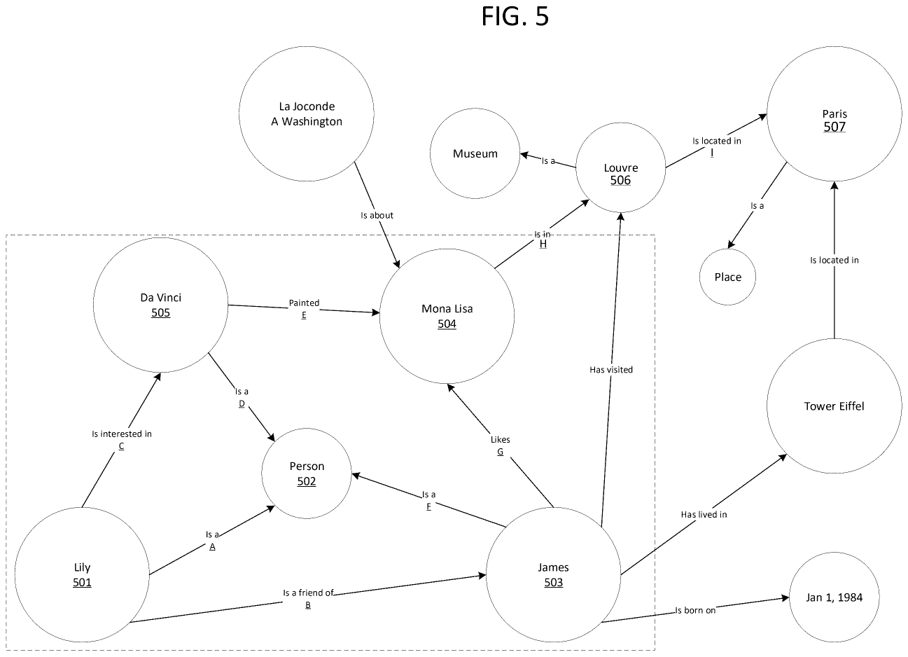

According to further aspects, another inputted question may be a question inputted by Lily in FIG. 5, and may specify: “where is good place to visit for Lily and James?”. For this question, the KGLLM may generate multiple logical reasoning steps to answer the question. For example, the multiple logical reasoning steps may include (i) what is the relationship between Lily and James, (ii) what interest Lily and James have in common, and (iii) what countries are associated with the common interest. Although three logical reasoning steps are described herein, aspects of the present disclosure are not limited thereto, such that more or less logical reasoning steps may be generated from the inputted question based on the complexity of the question.

In operation 403, a knowledge graph corresponding to the inputted question may be identified and inputted into the KGLLM. Based on the question of “where is good place to visit with James?” inputted by user named Lily, the KGLLM may identify knowledge graph of FIG. 5 as being relevant to the question being asked and may be inputted to the KGLLM. According to exemplary aspects, a knowledge graph or a portion of the knowledge graph (or subgraph) may be identified and inputted into the KGLLM for each of the logical reasoning steps. Although a single knowledge graph is disclosed as being utilized by the KGLLM for answering the question inputted, aspects of the present disclosure are not limited thereto, such that different knowledge graphs or subgraphs may be utilized at different logical reasoning steps.

According to exemplary aspects, knowledge graphs may represent structured information, and may have wide ranging applications, including information retrieval, question answering, decision making and the like. Knowledge graph may refer to a collection of interlinked data entities or topological information. According to exemplary aspects, topological information of the knowledge graph may include entities and/or edges/relationships. However, aspects of the present disclosure are not limited thereto, additional components may be included.

According to further aspects, a knowledge graph may refer to a directed heterogeneous graph including multiple nodes and edges as exemplarily illustrated in FIG. 5. The knowledge graph may be analyzed as a whole or at select portions for computational efficiency. Select portions of the knowledge graph may be referred to as a sub-graph. With reference to FIG. 5, the dashed box may indicate a sub-graph. According to exemplary aspects, a sub-graph may be larger or smaller than the sub-graph indicated in FIG. 5 and may include at least one triple. A triple may refer to a pair of nodes connected by an edge.

Further, each of the nodes may represent an entity, an object, an event, a concept or the like. For example, nodes 501, 502, 503, 504 and 505 of FIG. 5 may include data values, such as “Lily”, “person”, “James”, “Mona Lisa” and “Da Vinci”, respectively. Each of the edges may represent a relationship and/or a relationship type between a pair of nodes, and may further indicate a direction of such relationship. For example, edges A, B, C, D, E, F and G of FIG. 5 may include relationship or relationship types of “is a”, “is a friend of”, “is interested in”, “is a”, “painted”, “is a”, and “likes”, respectively.

Accordingly, based on FIG. 5, a combination or triple of node 501, node 503 and edge B indicates that “Lily”→“is a friend of”→“James”. Similarly, a combination or triple of node 503, node 504 and edge G indicates that “James”→“likes”→“Mona Lisa”. Based on a direction of the edge, a triple may include a head node and a tail node. The head node may refer to a node from which the relationship or directional arrow originates from, and the tail node may refer to a node towards which the relationship or the directional arrow is directed. Accordingly, a knowledge graph may include multiples of such triples.

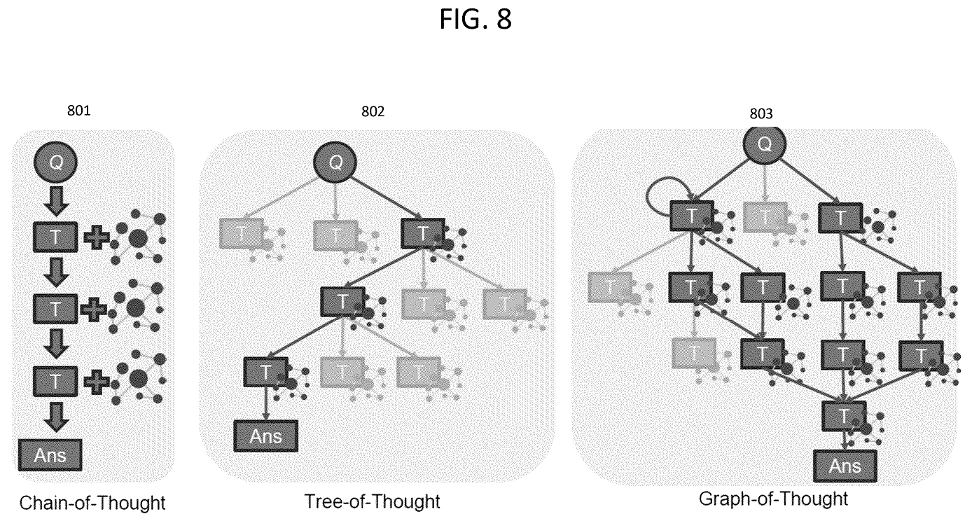

In operation 404, a reasoning framework to apply to the inputted question, among multiple reasoning frameworks, is determined. As exemplarily illustrated in FIG. 8, multiple reasoning frameworks may include a chain-of-thought (CoT) framework 801, a tree-of-thought (ToT) framework 802, and a graph-of-thought (GoT) framework 803. The reference reasoning frameworks may be discussed in more detail with reference to FIG. 8 provided below.

In operation 405, a logical reasoning step generated from the inputted question is processed by the KGLLM for generating a corresponding text or prompt. Based on the generated prompt or text, one or more entities may be identified or recognized for linking with a corresponding portion of the knowledge graph or subgraph. More specifically, for each of the logical reasoning steps, entities may be identified and classified into predefined categories, such as names of persons, organizations, quantities and the like. Then these classifications and/or identified entities may be utilized to match with one or more nodes in the knowledge graph to identify a relevant portion of the knowledge graph, or a subgraph, and link the identified subgraph to the respective reasoning step or question. Based on the linked or connected portion of the knowledge graph or the subgraph, corresponding pieces of information may be retrieved based on the generated text or prompt for the respective logical reasoning step.

For example, the logical reasoning step (e.g., what is the relationship between Lily and James) may prompt the KGLLM to identify a relationship between Lily and James using the knowledge graph or subgraph. In this regard, node 501 and node 503 connected by edge B of the knowledge graph or subgraph indicates that “Lily”→“is a friend of”→“James”.

Another or subsequent logical reasoning step (e.g., what does Lily and James have in common) to be processed in a subsequent iteration of operation 405 (after preceding logical reasoning step processes through step 407) may prompt the KGLLM to identify an interest or likes of Lily and James using the knowledge graph or subgraph. In this regard, node 501 and node 505 connected by edge C of the knowledge graph or subgraph indicates that “Lily”→“is interested in”→“Da Vinci”. Also, node 503 and node 504 connected by edge G of the knowledge graph or subgraph indicates that “James”→“likes”→“Mona Lisa”.

Another or subsequent logical reasoning step (e.g., what countries are associated with the common interest) to be processed in a subsequent iteration of operation 405 (after preceding logical reasoning step processes through step 407) may prompt the KGLLM to identify a country that is associated with interests and likes of Lily and James using the knowledge graph or subgraph. In this regard, node 505 and node 504 connected by edge E of the knowledge graph or subgraph indicates that “Da Vinci”→“painted”→“Mona Lisa”. Also, node 504 and node 506 connected by edge H of the knowledge graph or subgraph indicates that “Mona Lisa”→“is in”→“Louvre”. Further, node 506 and node 507 connected by edge I of the knowledge graph or subgraph indicates that “Louvre”→“is located in”→“Paris”.

According to exemplary aspects, every logical reasoning step may interact with and retrieve new information from the knowledge graph, which may in aggregation derive an answer to the inputted question.

In an example, two different ways for the logical reasoning step to interact with the knowledge graph is provided, agentic and graph exploration. In the agentic or agent-based approach, the KGLLM may be equipped with a set of predefined actions, and based on the thought or logical reasoning step, the KGLLM selects one of the predefined actions to connect with the knowledge graph. Accordingly, one logical reasoning step in the reasoning chain may be composed of the interleaved set of actions: thought→action→retrieved data. For example, the agentic approach may implement four actions, including (1) RetrievedNode (Text), (2) NodeFeature (NodeID, FeatureName), (3) NeighborCheck (nodeID, EdgeType), and (4) NodeDegree (NodeID, EdgeType). The RetrieveNode action may identify a related node in the knowledge graph with a semantic search. NodeFeature action may retrieve textual information for a specific node from the knowledge graph. NeighborCheck action may retrieve the neighbors information for a specific node. Lastly, NodeDegree action may return a degree (or number of neighbors) for a given node and edge type.

The graph exploration approach may include a method that automatically searches the knowledge graph based on the generated text or prompt from the thought or logical reasoning step. This method may follow a sequence of actions in one step: thought→graph-exploration→retrieved triples. In this case, the datasets may not count with anchor entities, so the entities may be extracted directly from the text or prompt. According to exemplary aspects, the graph exploration may follow a discovery and prune approach. More specifically, for each logical reasoning step, the knowledge graph is explored based on the mentioned entities that have not yet been visited. More specifically, the search and prune approach may be implemented for relations or edges first, and entities or nodes second. The discovery and prune approach may be repeated for maximum depth in, for example, the CoT framework.

In the discovery portion of the discovery and prune approach, the KGLLM may be presented with an anchor entity, and corresponding relationships or edges connected to the anchor entity may be retrieved. In an example, a head node may be designated as the anchor entity, and tail nodes for the head node may be identified based on the retrieved relationships or edges.

In the prune portion of the discovery and prune approach, with the edges or entities retrieved from the discovery phase of the discovery and prune approach, the KGLLM may be prompted to select only the entities and edges that are relevant for answering the inputted question.

In operation 406, a determination is made whether or not the logical reasoning step that was processed was the last logical reasoning step among the multiple logical reasoning steps generated in operation 404. If the logical reasoning step processed in operation 405 is not the last logical reasoning step among the multiple logical reasoning steps generated in operation 404, the method proceeds to operation 407 for processing of a subsequent logical reasoning step. On the other hand, if the logical reasoning step processed in operation 405 is the last logical reasoning step among the multiple logical reasoning steps generated in operation 404, the method proceeds to operation 408.

In operation 407, KGLLM is conditioned with the retrieved pieces of information from the knowledge graph or subgraph based on the processed logical reasoning step, and selects a subsequent logical reasoning step. Leveraging information from knowledge graphs with LLMs may be a complicated task due to high dimensional space of both language and the knowledge graphs, in which nodes and edges may come in different types, representing entities, objects events, concepts and the like. However, by breaking up the inputted questions into multiple logical reasoning steps for generating a reasoning chain, and by conditioning the KGLLM after processing a logical reasoning step, even a highly complex question may be methodically and accurately be processed using the knowledge graph.

According to exemplary aspects, if CoT framework 801 is selected in operation 403, the KGLLM temporarily stores the output or the retrieved pieces of information in operation 405, then the next logical reasoning step is set to be processed. The subsequent logical reasoning step may be a function of the input and all of the previous logical reasoning steps.

However, if ToT framework 802 or GoT framework 803 is selected in operation 403, then KGLLM determines which subsequent logical reasoning step, among multiple possible logical reasoning steps, should be selected based on the retrieved pieces of information in operation 405. For example, if there are three possible logical reasoning steps available, subsequent to the processed logical reasoning step, in the ToT framework 802 or GoT framework 803, only one may be selected by the KGLLM based on the retrieved pieces of information or output in operation 405.

In operation 408, pieces of information retrieved for each of the logical reasoning steps generated in operation 404 are combined for generating an answer to the inputted question. According to exemplary aspects, the KGLLM may provide an output including the generated answer, along with outputs generated for one or more of the logical reasoning steps to provide transparency to the logical reasoning performed by the KGLLM to arrive at the final answer.

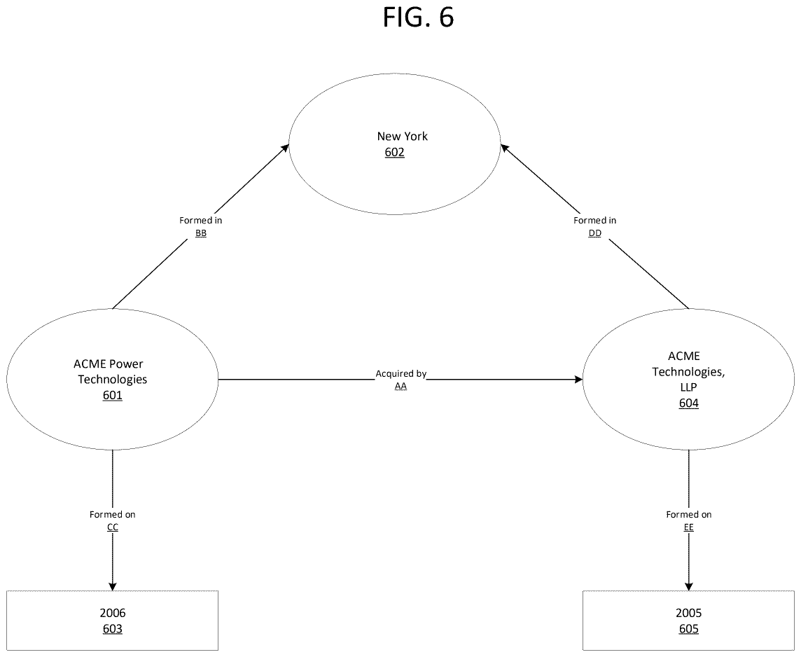

FIG. 6 illustrates a knowledge graph generated from textual information in accordance with an embodiment.

According to exemplary aspects, knowledge graphs may be generated based on acquired data. Each of the nodes in the knowledge graphs may represent or correspond to a specific data entity, such as an author name, a specific car model, a specific city and the like. A knowledge graph may include one or more triples that are connected with one another. A triple may include a pair of nodes connected with an edge there between. According to exemplary aspects the edge may indicate a directionality of a relationship to designate one node of the pair as a head node and designate the other node of the pair as a tail node.

Moreover, according to exemplary aspects, knowledge graphs may be formed based on information stored in one or more databases, or based on textual information provided on various documents, emails, text communications and the like. For example, text of “ACME Power Technologies, Inc. (the Company, ACME), established in New York in 2006, was bought by ACME Technologies LLLP (the LLLP), a limited liability limited partnership formed in New York in September 2005” found in a document may generate a knowledge graph as illustrated in FIG. 6.

As illustrated in FIG. 6, based on the above noted text, node 601 indicating “ACME Power Technologies”, node 602 indicating “New York”, node 603 indicating year “2006”, node 604 indicating “ACME Technologies, LLP”, and node 605 indicating year “2005” may be generated for forming a knowledge graph. Moreover, edges AA, BB, CC, DD and EE indicating relationships of “acquired by”, “formed in”, “formed on”, “formed in”, and “formed on”, respectively, are generated for the knowledge graph. As illustrated in FIG. 6, a triple of node 601, node 604 and edge AA may indicate that “ACME Power Technologies”→“acquired by”→“ACME Technologies, LLP”, which reflects the information provided in the text above (i.e., “ACME Power Technologies, Inc. (the Company, ACME). . .was bought by ACME Technologies LLLP (the LLLP)”). Moreover, a combination of a first triple of node 604, node 602 and edge DD may indicate that “ACME Technologies, LLP”→“formed in”→“New York”, and a second triple of node 604, node 605 and edge EE may indicate that “ACME Technologies, LLP”→“formed on”→“2005”, may correspond to the information provided in the text above (i.e., “ACME Technologies LLLP (the LLLP), a limited liability limited partnership formed in New York in September 2005”).

According to exemplary aspects, knowledge graphs may be generated by a processor or one of the machine learning (ML) or artificial intelligence (AI) algorithms or models.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

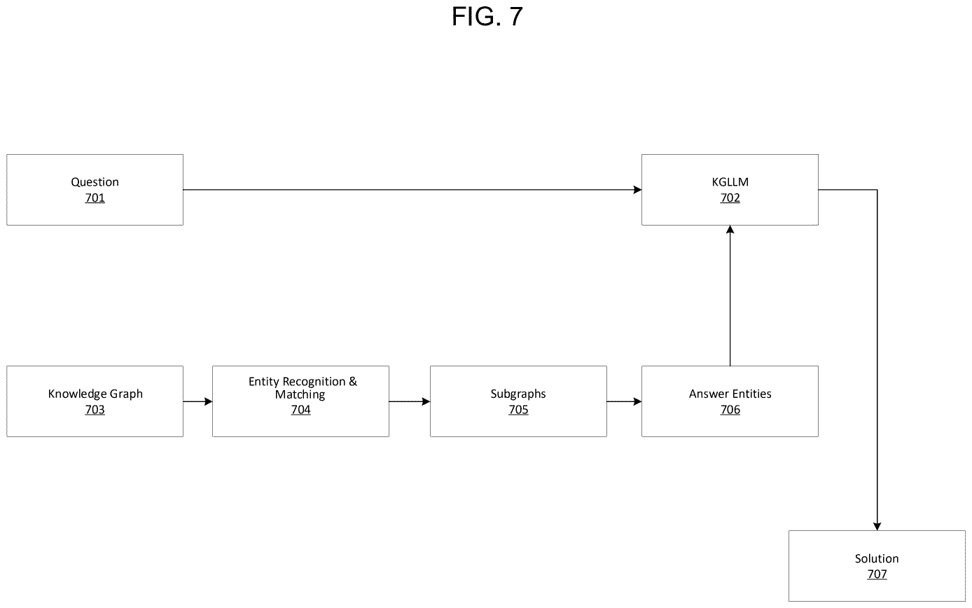

FIG. 7 illustrates a system flow of a KGLLM system in accordance with an embodiment.

According to exemplary aspects, the KGLLM system may connect with a knowledge graph more than once to provide an answer to an inputted question. More specifically, a question may be broken into multiple sub-questions or logical reasoning steps, and each of the multiple sub-questions or logical reasoning steps may individually connect with the knowledge graph to retrieve pieces of information for providing an intermediate output for ultimately deriving an answer to the inputted question.

The system flow of KGLLM system involves processing of a question 701, KGLLM 702, knowledge graph 703, entity recognition and matching 704, subgraph retrieval 705, and answer entities 706 for generating a solution 707.

According to exemplary aspects, the question 701 may be a natural language question provided in text, and may involve multiple levels of logic to arrive at an answer. The question 701 may be provided to the KGLLM 702 for processing.

The KGLLM 702 may be configured to break the question down into multiple logical reasoning steps. The KGLLM 702 may include an underlying LLM that may be configured to communicate with the knowledge graph at every logical reasoning step for processing of the question 701.

The knowledge graph 703 may be communicated with the KGLLM 702 to retrieve subgraphs 705. According to exemplary aspects, for one of the logical reasoning step, the KGLLM 702 may communicate with the knowledge graph 703 to retrieve one or more subgraphs 705. According to exemplary aspects, the subgraphs 705 may include a portion of the knowledge graph including one or more entities and relationships indicated in the logical reasoning step.

More specifically, the entity recognition and matching 704 may link each of the logical reasoning steps generated by the KGLLM 702 to the knowledge graph 703 by performing the tasks of named entity recognition and entity matching and linking.

The named entity recognition is directed to locating and classifying named entities included in the natural language into predefined categories, such as names of persons, organizations, quantities and the like. For example, the named entity recognition may identify “Barack Obama” as belonging to a person category. The performance of the named entity recognition operation may allow identification of important elements in a text that are likely to be found in the knowledge graph.

The entity matching and linking may link the named entities to corresponding nodes in the knowledge graph. More specifically, based on the named entities, a select portion of the knowledge graph 703 may be identified as being relevant to one of the logical reasoning steps. More specifically, entities in the knowledge graph 703 that may with the named entities may be identified as the relevant portion, which may later be identified as one of the subgraphs 705. In an example, the entity matching process may involve disambiguating different expressions that refer to the same concept in the knowledge graph. The entity matching process may help to consolidate information into a single node in the knowledge graph 703. The connection with the knowledge graph 703 may provide additional context and relationship information, aiding the KGLLM 702 to better interpret the text.

Based on the subgraphs, one or more answer entities 706 may be provided and inputted to the KG LLM 702. According to exemplary aspects, the answer entities 706 may include one or more triples including a pair of nodes connected by an edge. However, aspects of the present disclosure are not limited thereto, such that the answer entities 706 may include a path from one node to another node in the knowledge graph. In an example, the one or more triples may include at least an entity or relationship indicated in the respective logical reasoning step.

The KGLLM 702 in receipt of the answer entities 706, may select one of the provided answer entities 706, if more than one is provided, based on a calculated probability for each of the answer entities 706 that the respective answer entity may lead to a correct answer to the inputted question 701. The KGLLM 702 may combine answer entities 706 for all of the multiple logical reasoning steps and provide the solution 707, which is an answer generated for the question 701.

FIG. 8 illustrates exemplary reasoning frameworks applied to a KGLLM system in accordance with an embodiment.

According to exemplary aspects, CoT framework 801 may refer to a framework that delineates complex tasks into a sequence of logical reasoning steps towards a final resolution. More specifically, the CoT framework 801 may utilize a reasoning method in which a sequence of logical reasoning steps is generated sequentially, where each logical reasoning step builds upon the previous one, to eventually lead to a final conclusion.

The CoT framework 801 may leverage the KGLLM to articulate a succession of logical reasoning steps, guiding the KGLLM towards generating analogous reasoning chains for novel tasks. Each of the sequence of logical reasoning steps may then later be combined with a corresponding knowledge graph or portion of knowledge graph (or subgraph) for providing a respective output. As illustrated in FIG. 8, each of the logical reasoning steps are arranged sequentially and proceeds in a singular direction. In an example, the CoT framework 801 may be appropriate where only a singular reasoning path is available. For example, referring to FIG. 5, there may be only one possibility of which country the Louvre may be located in.

According to exemplary aspects, the ToT framework 802 may extend the CoT framework 801 by considering multiple possible paths at each logical reasoning step, forming a tree structure. The ToT framework 802 may include multiple levels of logical reasoning steps, until final answer is reached. According to exemplary aspects, each level includes one or more multiple reasoning steps, but only one reasoning step may be selected for each level for forming a path towards the final answer as the ToT framework 802 moves down each level. The ToT framework 802 allows the KGLLM to navigate the problem space, exploring multiple reasoning paths, while being influenced by the results from the pieces of information retrieved from the knowledge graph for the respective logical reasoning step. The ToT framework 802 may utilize a branching factor as an input parameter, and at every logical reasoning step, the KGLLM may generate the branching factor for the logical reasoning step. A state evaluator is then presented with all of the logical reasoning steps for its respective level, and selects one of the available logical reasoning steps to proceed to the next logical reasoning step in a subsequent level.

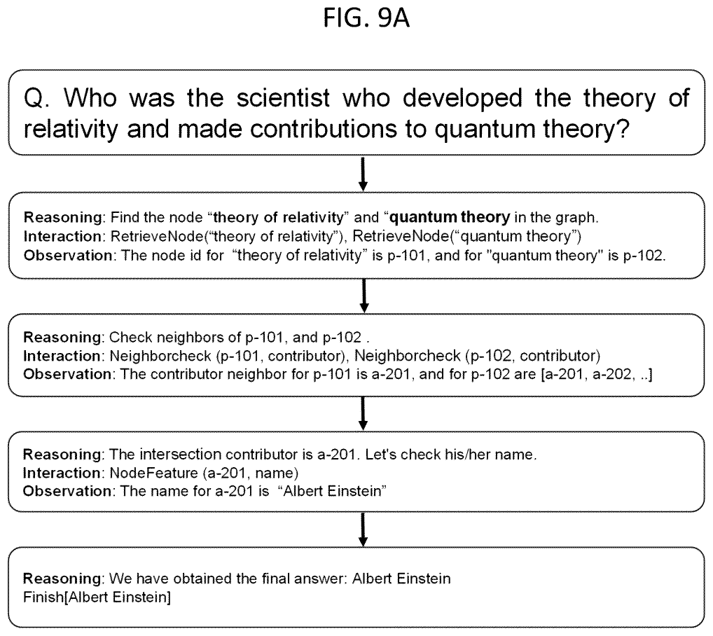

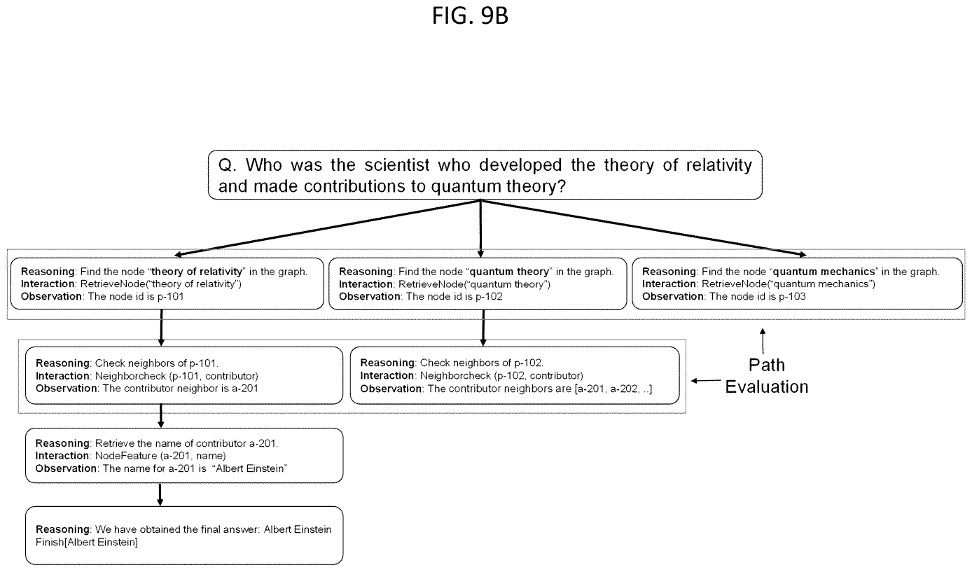

A more detailed implementation of the ToT framework 802 is illustrated in FIGS. 9A-9B. As provided in FIGS. 9A-9B, for each level of nodes, thoughts or logical reasoning steps, one of the KGLLM actions is performed with respect to a knowledge graph and a corresponding observation is made based on the knowledge graph. Based on the observations, one of the nodes for the respective level is selected for proceed to the next level of nodes based on votes or probability of reaching a correct solution. As shown in FIGS. 9A-9B, the next level of nodes corresponds or flow from the selected node from the previous level. Non-selected nodes are stopped from continuing further to conserve computing resources. This process may continue for each level until the final level or answer is reached.

Further, the ToT framework 802 may operate on the LLM's ability to generate text hierarchically, with a central topic or idea leading to branching subtopic and details. Such framework may mirror how the KGLLM may expand on a specific prompt by generating increasingly specific and related text, similar to a tree structure. The ToT framework 802 may provide tree search strategies, where the KGLLM may explore multiple branches prior to committing to a particular path. In the exploration, each of the branches of logical reasoning step may be integrated with corresponding knowledge graph or subgraph for identifying the particular path. The ToT framework 802 may evaluate the quality of each branch or logical reasoning step before selecting a particular branch or logical reasoning step for establishing a path towards the final answer.

In an example, the ToT framework 802 may provide three branches of logical reasoning steps for consideration stemming from the inputted question. Each of the three branches of logical reasoning steps may be integrated with corresponding knowledge graph or subgraph for exploration, before one of branches of the logical reasoning step may be selected as a path. Upon selection among the first set of branches of logical reasoning steps, branches or logical reasoning steps stemming from the selected branch or logical reasoning step are explored to determine the next branch in the path towards the final solution. Similar to the first selection, each of the second set of branches or logical reasoning steps are provided with corresponding knowledge graph or subgraph for exploration, before one of the second set of branches or logical reasoning steps may be selected as the next branch or logical reasoning steps. The above noted steps may be performed for each of the selected branches or logical reasoning steps until a path towards the ultimate answer is established.

According to further aspect, the ToT framework 802 utilizes multiple components, including a thought generator, a state evaluator and a search algorithm. With respect to the thought generator, every thought or logical reasoning step may refer to an individual unit generated by the KGLLM. Each thought or logical reasoning step may independently connect with the knowledge graph or a portion of the knowledge graph.

The state evaluator may select one of the logical reasoning steps for a respective level based on the probability of reaching the right solution. Once one of the logical reasoning steps within the respective level is selected, the non-selected logical reasoning steps or thoughts are discontinued. In order to reach a selection, a probability of reaching a correct answer for each of the thoughts or logical reasoning steps within the respective level is calculated, and then, the thought or logical reasoning step with the highest probability is selected.

The search algorithm may define an exploration method utilized for the ToT framework 802. More specifically, the search algorithm may refer to a process of visiting each node or logical reasoning step in a tree data structure exactly once, which may involve retrieving, updating or deleting nodes or logical reasoning step. According to exemplary aspects, the search algorithm may include breath-first search (BFS) algorithm. The BFS algorithm may explore nodes level by level to ensure that all nodes at a given depth or level are visited before moving on to the next level. Accordingly, the BFS algorithm may be effective in exploring each level until reaching the stopping criteria, such as maximum depth.

The GoT framework 803 may refer to an advanced reasoning framework that represents thought processes as interconnected nodes within a graph, where each node corresponds to a logical reasoning step or concept. The GoT framework 803 may facilitate complex, non-linear reasoning by leveraging the relationships between concepts. The GoT framework 803 may model the reasoning process as directed by the knowledge graph. One of the differences between the ToT framework 802 and the GoT framework 803 may include a merge function, which may create one node from merging of two separate chains. The GoT framework 803 may include the thought generator, the state evaluator and the search algorithm similar to the ToT framework 802, and may additionally include two additional components: an aggregate transformation, and a refining transformation.

According to exemplary aspects, the aggregation transformation may aggregate arbitrary thoughts or logical reasoning steps into new ones to combine and reinforce the advantages of these thoughts while removing their disadvantages. More formally, the aggregation transformation may create a new thought descending from two different branches at the previous level. In the graph model, the aggregation transformation may be represented by adding outgoing edges from the two previous nodes or logical reasoning steps to the new merged thought or logical reasoning step.

According to exemplary aspects, the refining transformation may be represented as a self-loop in the graph structure and may represent a refining function of a current thought or logical reasoning step. The self-loop may correspond to or be equivalent to the self-feedback mechanisms to allow the KGLLM to auto-correct one or more discrepancies in its reasoning process.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a plurality of communications with a knowledge graph by a knowledge graph configured large language model (KGLLM) for answering a question, the method comprising:
receiving, at the KGLLM executed by a processor, the question;
generating, by the KGLLM, a plurality of logical reasoning steps based on the received question;
identifying and inputting, to the KGLLM, the knowledge graph based on the received question;
for each of the plurality of logical reasoning steps:
generating a prompt for a logical reasoning step,
connecting to the knowledge graph based on the generated prompt, and
retrieving corresponding pieces of information from the knowledge graph based on the generated prompt; and
combining the pieces of information retrieved in each of the plurality of logical reasoning steps for deriving an answer to the question.

2. The method according to claim 1, wherein the question received is provided in natural language text.

3. The method according to claim 1, wherein the knowledge graph includes a plurality of triples, wherein each of the triples includes a pair of nodes connected by an edge, wherein a node corresponds to a data entity and the edge indicates a relationship between the nodes, and wherein the edge indicates a directionality of the relationship.

4. The method according to claim 1, further comprising:
determining, by the KGLLM, a reasoning framework to apply to the question received among a plurality of reasoning frameworks.

5. The method according to claim 4, wherein the reasoning framework is a chain-of-thought (CoT) framework.

6. The method according to claim 4, wherein the reasoning framework is a tree-of-thought (ToT) framework.

7. The method according to claim 4, wherein the reasoning framework is a graph-of-thought (GoT) framework.

8. The method according to claim 1, wherein the plurality of reasoning steps is sequentially arranged.

9. The method according to claim 1, wherein the plurality of reasoning steps is arranged across a plurality of levels.

10. The method according to claim 9, wherein each of the plurality of levels includes a single logical reasoning step.

11. The method according to claim 9, wherein at least one of the plurality of levels includes more than one logical reasoning step.

12. The method according to claim 11, wherein at least two logical reasoning steps in a first level of the plurality of levels merge to a single logical reasoning step in a second level of the plurality of levels.

13. The method according to claim 1, wherein the retrieved pieces of information include a triple from the knowledge graph, the triple including a pair of nodes connected with an edge.

14. The method according to claim 1, wherein the retrieved pieces of information include a knowledge graph path from one node to another node.

15. The method according to claim 1, wherein the KGLLM is configured to select a predefined action to perform, among a plurality of predefined actions, to connect with the knowledge graph.

16. The method according to claim 15, wherein the predefined action is selected based on the logical reasoning step.

17. The method according to claim 15, wherein the plurality of predefined actions includes:
identifying one or more related nodes in the knowledge graph with a semantic search,
retrieving textual information for a specific node from the knowledge graph,
retrieving neighbor information for the specific node, and
providing a number of neighbors for a given node and edge type.

18. The method according to claim 17, wherein the KGLLM is configured to automatically search the knowledge graph based on generated prompt for the logical reasoning step.

19. A system for performing a plurality of communications with a knowledge graph by a knowledge graph configured large language model (KGLLM) for answering a question, the system comprising:
a processor; and
a memory operatively connected to the processor via a communication interface, the memory storing computer readable instructions, when executed, causes the processor to:
receiving, at the KGLLM, the question;
generating, by the KGLLM, a plurality of logical reasoning steps based on the received question;
identifying and inputting, to the KGLLM, the knowledge graph based on the received question;
for each of the plurality of logical reasoning steps:
generating a prompt for a logical reasoning step,
connecting to the knowledge graph based on the generated prompt, and
retrieving corresponding pieces of information from the knowledge graph based on the generated prompt; and
combining the pieces of information retrieved in each of the plurality of logical reasoning steps for deriving an answer to the question.

20. A non-transitory computer readable medium configured to store instructions for performing a plurality of communications with a knowledge graph by a knowledge graph configured large language model (KGLLM) for answering a question, the instructions, when executed, cause a processor to perform the following:
receiving, at the KGLLM, the question;
generating, by the KGLLM, a plurality of logical reasoning steps based on the received question;
identifying and inputting, to the KGLLM, the knowledge graph based on the received question;
for each of the plurality of logical reasoning steps:
generating a prompt for a logical reasoning step,
connecting to the knowledge graph based on the generated prompt, and
retrieving corresponding pieces of information from the knowledge graph based on the generated prompt; and
combining the pieces of information retrieved in each of the plurality of logical reasoning steps for deriving an answer to the question.
